(19) United States
(12) Patent Application Publication
(10) Pub. No.: US 2018/0253455 A1
(43) Pub. Date: Sep. 6, 2018

(54) DATA PROCESSING SYSTEM AND DATA PROCESSING METHOD

(71) Applicant: HITACHI, LTD., Tokyo (JP)

(72) Inventor: Tomoaki AKITOMI, Tokyo (JP)

(21) Appl. No.: 15/756,383

(22) PCT Filed: Nov. 25, 2015
(86) PCT No.: PCT/JP2015/083044

§ 371 Date: Feb. 28, 2018

(51) Int. Cl. G06F 17/30; G06N 7/00; G06F 17/11

(52) U.S. Cl. CPC G06F 17/30315; G06F 17/30336; G06F 17/11; G06F 17/30442; G06N 7/005

(57) ABSTRACT

Provided is a data processing system for creating a model for optimizing input data including a plurality of columns, the system including a processor and a storage unit. The processor is configured to receive index data including information on a combination of the columns to serve as an index in optimization of the input data, and changeability information indicating if data in each column is allowed to be changed in the optimization, and create the model on the basis of the index data.

### TECHNICAL FIELD

The present invention relates to a data processing system and a data processing method.

### BACKGROUND ART

In recent years, a technology for clarifying unknown relationships among a large number of pieces of information in a society called “big data” has been developed. The purpose of clarifying the relationships among pieces of information is to optimize a real problem using an evaluation formula that represents the relationships among the pieces of information. Herein, real problems typically have a variety of constraints. Therefore, it is necessary to perform optimization so as to enhance an evaluation result obtained from the evaluation formula while satisfying the constraints.

However, an evaluation formula for the relationships among pieces of information that has been recursively determined from numerical values is not always an evaluation formula that is suitable for optimization for which the constraints are taken into consideration, and the resulting optimization effects may become significantly low depending on the constraints. To avoid such a problem, there is known a method of adding, by a user, a condition to an evaluation formula when the evaluation formula is generated. For example, Patent Literature 1 discloses a method in which among a plurality of columns of input data, a column or part of a column to be used for an evaluation formula is designated by a user as appropriate.

### CITATION LIST

### Patent Literature

Patent Literature 1: U.S. Pat. No. 8,171,001 A

### SUMMARY OF INVENTION

### Technical Problem

The technique of Patent Literature 1 is applicable only when a user knows an evaluation formula to be created in advance and the evaluation formula is simple enough for humans to understand. Therefore, when an unknown evaluation formula for obtaining a large optimization effect is to be created as described above, it would be impossible to select a column to be used for the evaluation formula in advance, which is problematic.

In view of the foregoing, the present invention provides a technique of creating, for data containing many variables, an evaluation formula that is suitable for optimizing the data, taking constraints into consideration in advance.

### Solution to Problem

For example, in order to solve the aforementioned problem, configurations recited in the claims are adopted. The present application includes a plurality of means for solving the problem, and one example thereof is a data processing system for creating a model for optimizing input data including a plurality of columns, the system including a processor and a storage unit. The processor is configured to receive index data including information on a combination of the columns to serve as an index in optimization of the input data, and changeability information indicating if data in each column is allowed to be changed in the optimization, and create the model on the basis of the index data.

According to another example, there is provided a data processing method for creating a model for optimizing input data including a plurality of columns, the method including, receiving, with a processor, index data including information on a combination of the columns to serve as an index in optimization of the input data, and changeability information indicating if data in each column is allowed to be changed in the optimization, and creating, with the processor, the model on the basis of the index data.

### Advantageous Effects of Invention

According to the present invention, it is possible to create, for data containing many variables, an evaluation formula that is suitable for optimizing the data, taking constraints into consideration in advance. It should be noted that further features related to the present invention will become apparent from the description of the specification and the accompanying drawings. In addition, other problems, configurations, and advantageous effects will become apparent from the following description of embodiments.

### BRIEF DESCRIPTION OF DRAWINGS

FIG. 1 is a system configuration diagram of a data processing system in Embodiment 1.

FIG. 2 shows a basic flow of Embodiment 1.

FIG. 3 shows a flow illustrating an index generation step (211) in FIG. 2.

FIG. 4 shows an example of a specific data form of past explanatory data.

FIG. 5 shows an example of a specific data form of past objective data.

FIG. 6 shows an example of a specific data form of each of an optimization configuration parameter and input data for optimization.

FIG. 7 shows an example of a specific data form of index data.

FIG. 8 shows a flow illustrating an optimization step (213) in FIG. 2.

FIG. 9 is a system configuration diagram of a data processing system in Embodiment 2.

FIG. 10 shows a basic flow of Embodiment 2.

FIG. 11 shows a flow illustrating a to-be-verified data separation step (1002) in FIG. 10.

FIG. 12 shows an example of a specific data form of verification/separation information data.

FIG. 13 shows an example of a specific data form of execution result data.

FIG. 14 shows a flow illustrating a validity verification step (1005) in FIG. 10.

FIG. 15 shows an example of a specific data form of an index validity table.

FIG. 16 shows a flow illustrating an index generation step (1001) in FIG. 10.

### DESCRIPTION OF EMBODIMENTS

Hereinafter, embodiments of the present invention will be described with reference to the accompanying drawings. Although the accompanying drawings illustrate specific embodiments in accordance with the principle of the present invention, these are only for understanding of the present invention, and should never be used to narrowly construe the present invention. It should be noted that components that are common throughout the drawings may be denoted by the same reference numerals.

### Embodiment 1

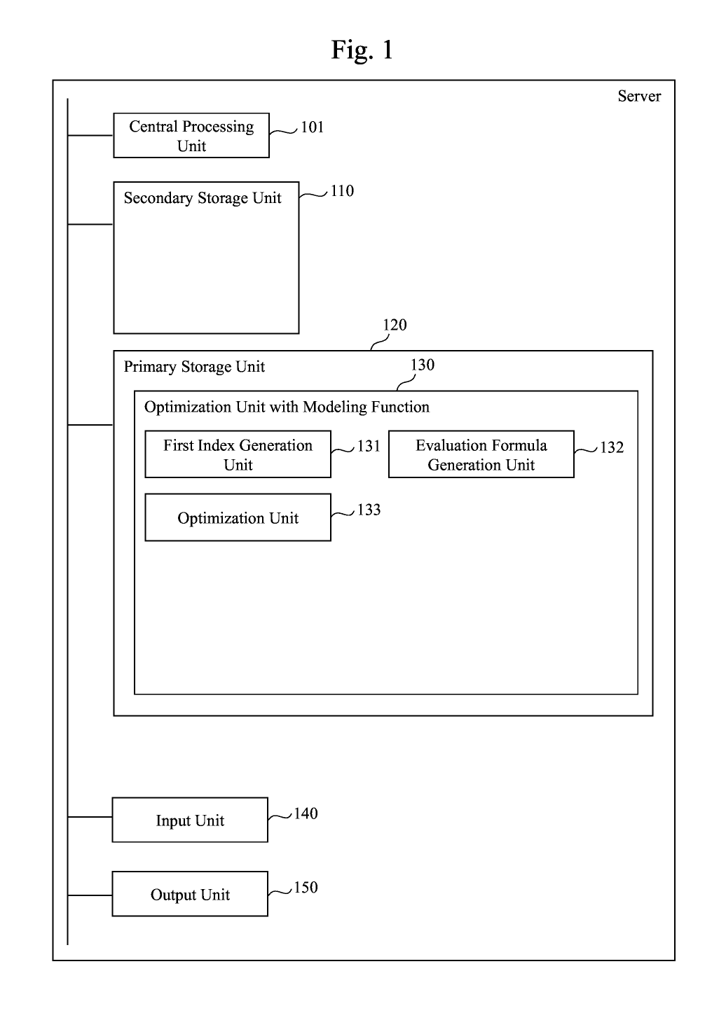

Hereinafter, an embodiment of the present invention will be described with reference to the drawings. FIG. 1 is a system configuration diagram of a data processing system in this embodiment. The data processing system is a system that analyzes data and creates a model. Hereinafter, an example in which an evaluation formula for optimizing data is created as a model will be described.

The data processing system includes a central processing unit 101, a secondary storage unit 110, a primary storage unit 120, an input unit 140, and an output unit 150. The data processing system is implemented by a common computer, for example, and is constructed as a server system herein.

The central processing unit 101 is a processor that executes programs stored in the primary storage unit 120.

The secondary storage unit 110 is a large-capacity nonvolatile storage unit, such as a magnetic storage unit or flash memory, for example. It should be noted that information stored in the secondary storage unit 110 may also be stored in the primary storage unit 120 so as to allow for higher-speed access to the information.

The primary storage unit 120 is a high-speed, volatile storage unit, such as DRAM (Dynamic Random Access Memory), for example. The primary storage unit 120 stores an operating system (OS) and an application program. When the central processing unit 101 executes the operating system, the basic function of the computer is implemented, and when the central processing unit 101 executes an application program, a function provided by the computer is implemented.

Specifically, the primary storage unit 120 stores a program for implementing an optimization unit 130 with a modeling function. The optimization unit 130 with the modeling function includes a first index generation unit 131, an evaluation formula generation unit 132, and an optimization unit 133.

Each processing module of the optimization unit 130 with the modeling function is implemented through execution of a program corresponding to each processing module by the central processing unit 101 (processor), for example. Therefore, in the following description, a process that is performed by the processing module in FIG. 1 may be rephrased as a process that is performed by the processor.

It should be noted that a program that is executed by the central processing unit 101 is provided to the computer via a nonvolatile storage medium or a network. Therefore, the computer may include an interface that reads the storage medium (e.g., CD-ROM or flash memory).

The input unit 140 is a user interface, such as a keyboard or a mouse. The output unit 150 is a user interface, such as a display device or a printer.

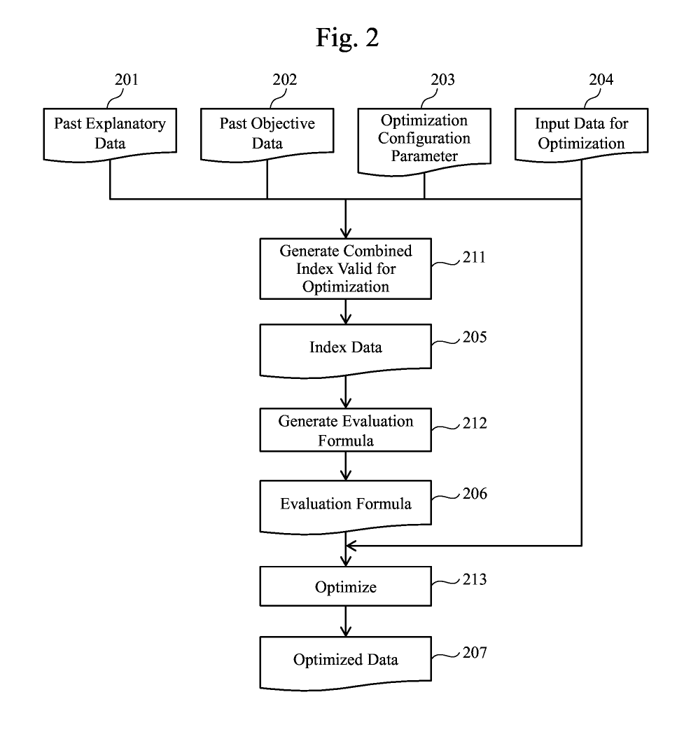

FIG. 2 shows a basic flow of Embodiment 1. The flow of the present system includes a first stage of generating an index that is valid for optimizing data and generating an evaluation formula on the basis of the index, and a second stage of optimizing data on the basis of the evaluation formula. This embodiment has a characteristic in that when a problem to be optimized is known in advance, an evaluation formula is learnt from past data so that the optimization goes well. With such a learning function, an evaluation formula can be constructed automatically even when a large volume of data is input and it is difficult for a human to construct an evaluation formula for optimizing the data.

As shown in FIG. 2, past explanatory data 201, past objective data 202, an optimization configuration parameter 203, and input data 204 for optimization are input to the present system.

The past explanatory data 201 is explanatory data (explanatory variable) in the past, and is basically data having the same columns as the input data 204 for optimization.

The past objective data 202 is an objective index (objective variable) in the past. As the past objective data 202, the value of an objective index corresponding to given data in the past explanatory data 201 is stored.

The input data 204 for optimization is input data to be optimized. In addition, the optimization configuration parameter 203 is a parameter describing the optimization constraints and the like.

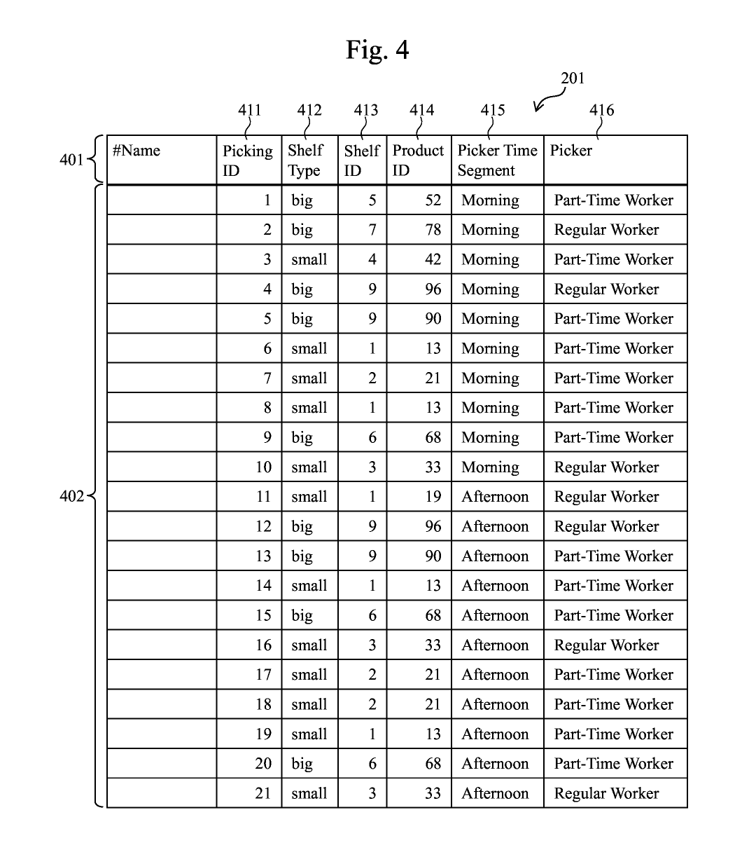

Hereinafter, the past explanatory data 201, the past objective data 202, the optimization configuration parameter 203, and the input data 204 for optimization will be described in detail. It should be noted that in this embodiment, information used by the present system does not depend on its data structure and thus may be represented by any data structure. Although FIGS. 4 to 6 show examples of data in a tabular form, any data structure that is appropriately selected from among a table, list, a database, and a cue, for example, may be used to store information.

FIG. 4 shows an example of a specific data form of the past explanatory data 201. The past explanatory data 201 includes a column name 401 and a data portion 402. In this embodiment, an optimization problem for improving the productivity of picking operations in a warehouse is given as an example. The past explanatory data 201 is data about, for a past time segment, who picked up which product onto which shelf.

The past explanatory data 201 includes, as the columns, a picking ID 411, shelf type 412, shelf ID 413, product ID 414, picker time segment 415, and picker 416. That is, each picking has attributes such as the type of a shelf onto which a product has been picked up, the ID of the shelf onto which the product has been picked up, the product ID of the product picked up, if the picker was a part-time worker or a regular worker, and if the working time segment of the picker was a morning shift or an afternoon shift. The purpose of this embodiment is to clarify with which attributes the picking productivity can be improved and to perform optimization so as to improve the picking productivity.

The past explanatory data 201 has a column in common with the past objective data 202 and the column can thus be associated with the past objective data 202. Herein, the picking ID 411 corresponds to the column common to the past explanatory data 201 and the past objective data 202. The other columns of the past explanatory data 201 are used to explain variations in the productivity that corresponds to the column of an objective index in the past objective data 202 having the same picking ID as the past explanatory data 201.

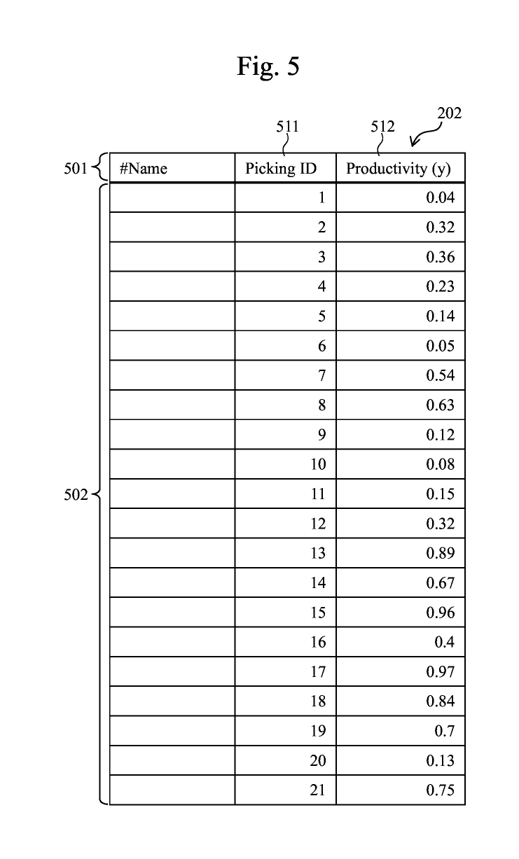

FIG. 5 shows an example of a specific data form of the past objective data 202. The past objective data 202 includes a column name 501 and a data portion 502. The past objective data 202 includes, as the columns, a picking ID 511 and productivity 512. The past objective data 202 has a column in common with the past explanatory data 201 and the column can thus be associated with the past explanatory data 201. Herein, the picking ID 511 corresponds to the column common to the past objective data 202 and the past explanatory data 201. In addition, the productivity 512 corresponds to the column of the objective index.

Although this embodiment illustrates an example of picking performed in a warehouse, it should be noted that the present invention can be applied to any given explanatory data and objective data.

In addition, in this embodiment, the past explanatory data 201 and the past objective data 202 are represented by different tables so that the data can be explained in a more common form. Although a single record is assigned to a single picking ID for each of the past explanatory data 201 and the past objective data 202 in this example, other examples are also possible depending on a problem to be solved. For example, an example is considered in which a single record is assigned to a single picking ID of the past objective data 202, and a plurality of records (that is, a plurality of picking operations) is assigned to a single picking ID of the past explanatory data 201. Therefore, in this embodiment, two tables are separately used based on the assumption of a common form in which an evaluation formula can be constructed even in response to an input when the number of samplings of explanatory data and the number of samplings of objective data are different as described above.

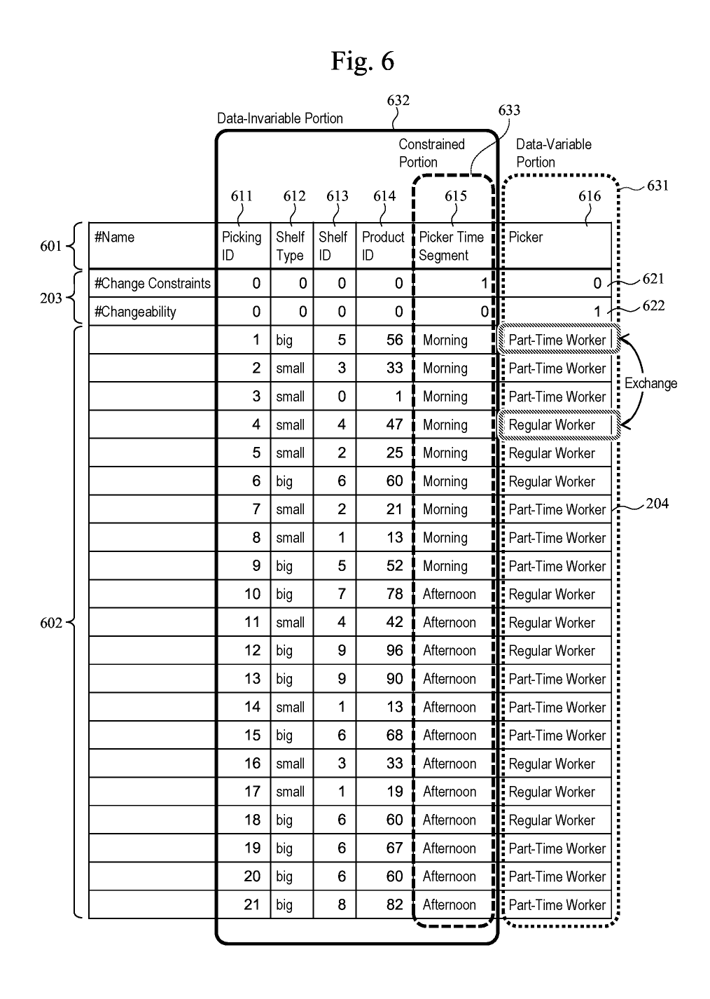

FIG. 6 shows an example of a specific data form of each of the optimization configuration parameter 203 and the input data 204 for optimization. The input data 204 for optimization is basically data in the same form as that of the past explanatory data 201. The input data 204 for optimization includes a column name 601 and a data portion 602. The input data 204 for optimization includes, as the columns, a picking ID 611, shelf type 612, shelf ID 613, product ID 614, picker time segment 615, and picker 616.

The optimization configuration parameter 203 includes constraints concerning changes in a combination of pieces of data in the input data 204 for optimization. In this embodiment, the optimization configuration parameter 203 includes two parameters that are a change constraint parameter 621 and a changeability parameter 622.

The changeability parameter 622 is a parameter for, when a combination of pieces of data in the input data 204 for optimization is changed, splitting the input data 204 for optimization into a data-variable portion 631 and a data-invariable portion 632. The data-variable portion 631 means a column in which data can be exchanged when a combination of pieces of data in the input data 204 for optimization is optimized, and the data-invariable portion 632 means a column in which data cannot be exchanged when a combination of pieces of data in the input data 204 for optimization is optimized and thus is fixed. Herein, the column corresponding to the data-variable portion 631 is set to “1” and the column corresponding to the data-invariable portion 632 is set to “0.”

It should be noted that the changeability parameter 622 is not limited to the example herein. When a plurality of columns is set as the data-variable portion 631, the changeability parameter 622 may include information on the priority among the plurality of columns of the data-variable portion 631. For example, as the data-variable portion 631, a given column may be set to “1” and another given column may be set to “2.” In such a case, the optimization unit 133 may be configured to preferentially change data in the column that is set to “2” when optimizing the input data 204 for optimization.

The change constraint parameter 621 is a parameter that defines the movable range of data in the column that is set as the data-variable portion 631 by the changeability parameter 622. Herein, a column in which data cannot be moved is set to “1” and a column in which data can be moved is set to “0.” Reference numeral 633 in FIG. 6 denotes a column in which the changeability parameter 622 is set to “1” and data in the column cannot thus be moved in the optimization. In this example, the picker time segment 615 is set to “1.” Therefore, the picker 616 as the data-variable portion 631 can be exchanged with only the picker 616 having the picker time segment 615 with the same value. For example, as shown in FIG. 6, the values of the pickers 616 each having the picker time segment 615 of “morning” can be exchanged Although shown herein is an example in which data whose change constraint parameter 621 has the same value can be exchanged, the present invention is not limited thereto. For example, it is also possible to provide a constraint such that data in a column can be exchanged when the values set as the change constraint parameter 621 are close to each other. Therefore, a variety of constraints can be set in advance.

Next, a summary of an evaluation formula will be described. The past explanatory data 201 is used to generate X of an evaluation formula Y=F(X) for optimization. Herein, it should be noted that in this embodiment, in order to generate the evaluation formula F(X) for general purposes, not a single column of the past explanatory data 201 directly becomes X of the evaluation formula F (X), but a combined index obtained by combining a plurality of columns becomes X, unlike a case of generating a common regression equation. The generation of the index will be described later.

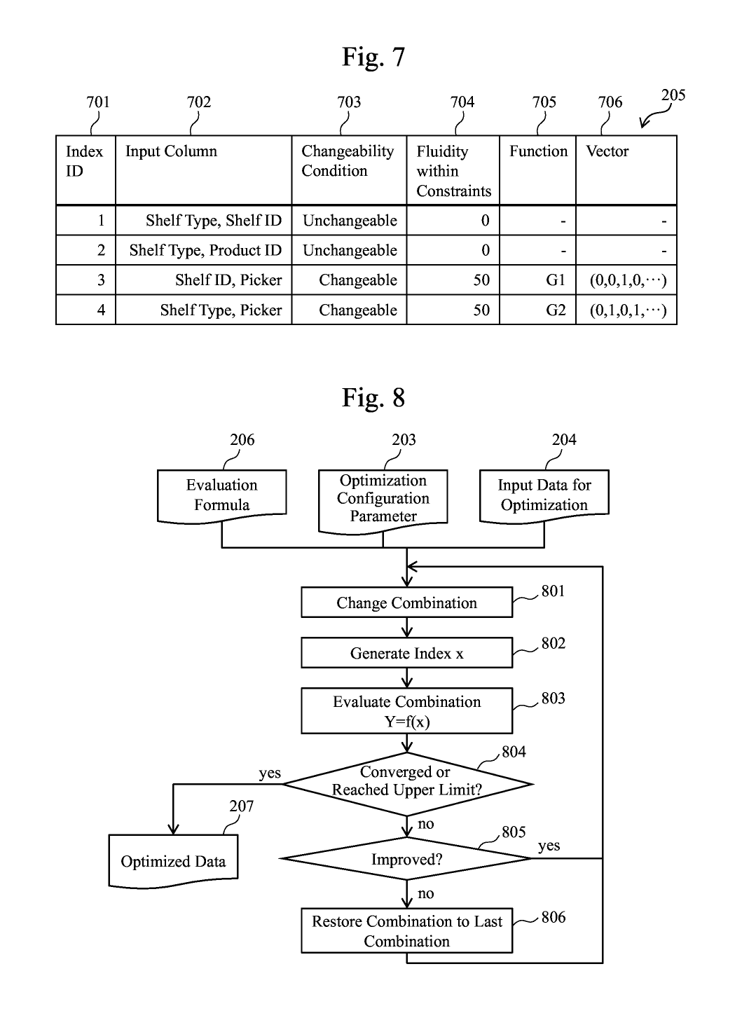

Next, the flow of FIG. 2 will be described. The first index generation unit 131, when optimizing the input data 204 for optimization under the conditions of the optimization configuration parameter 203, generates a combined index X that is valid as X of the evaluation formula F(X) (211). The detailed process herein will be described later with reference to FIG. 7. The first index generation unit 131 outputs index data 205 representing a combined index that is valid for optimization.

The evaluation formula generation unit 132 performs regression analysis of a column corresponding to the objective index of the past objective data 202 using the index data 205. Specifically, in this example, the objective index Y is the productivity of the past objective data 202. Therefore, the evaluation formula generation unit 132 constructs Y=F(X) for regression of the productivity Y from a plurality of indices stored in the index data 205 (212). The evaluation formula generation unit 132 outputs the thus constructed evaluation formula 206.

The optimization unit 133 performs optimization of the input data 204 for optimization under the conditions of the optimization configuration parameter 203 in order to improve the evaluation formula 206 (213). The optimization process will be described later. The optimization unit 133 outputs the thus optimized data 207.

The optimized data 207 is data obtained by changing a combination of pieces of data in the input data 204 for optimization. The optimized data 207 can have the same data form as the input data 204 for optimization.

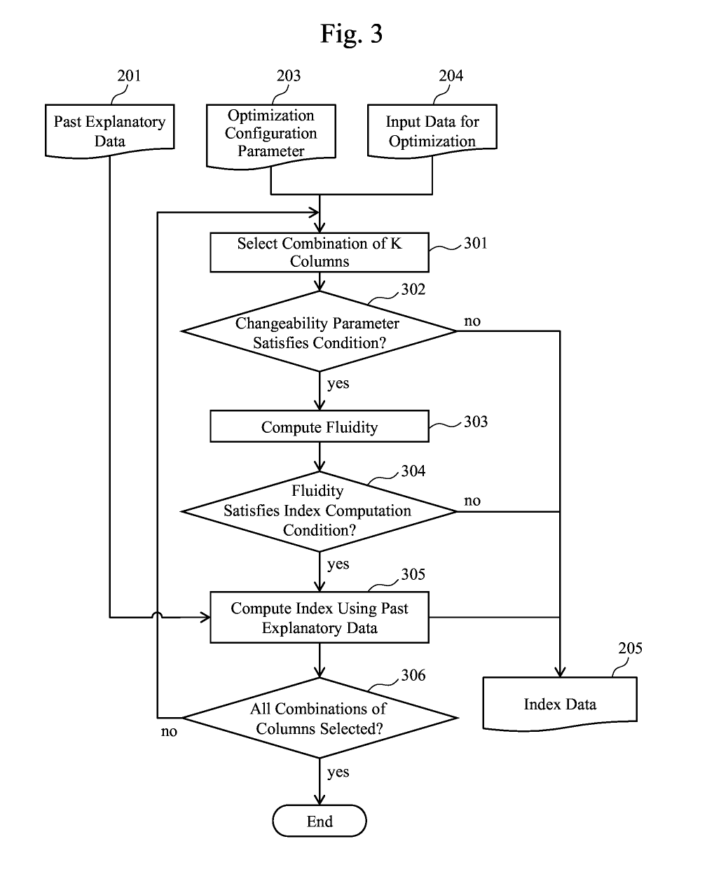

FIG. 3 shows a flow of step 211 in FIG. 2. In this flow, the index data 205 representing a combined index that is valid for optimization is created.

First, the first index generation unit 131 selects, using the optimization configuration parameter 203 and the input data 204 for optimization as input information, selects given K columns from among the columns of the input data 204 for optimization (301).

Next, the first index generation unit 131 reads from the optimization configuration parameter 203 the value of the changeability parameter 622 of each of the K columns selected in step 301. Herein, the first index generation unit 131 determines if the changeability parameter 622 of each of the K columns satisfies a given condition (302). Specifically, the first index generation unit 131 refers to the changeability parameter 622 of each of the K columns, and determines if the K columns include at least one data-variable portion 631 and at least one data-invariable portion 632. If the K columns are determined to include at least one data-variable portion 631 and at least one data-invariable portion 632, it follows that the combination of columns can be changed within the constraints. Therefore, an evaluation value can be improved when optimization is performed. The first index generation unit 131 stores in the index data 205 information on the indices that satisfy the condition (Yes in step 302).

Meanwhile, if the K columns are not determined to include at least one data-variable portion 631 and at least one data-invariable portion 632, that is, if all of the K columns are data-variable portions 631 or data-invariable portions 632, it means that the combination of columns cannot be changed within the constraints. Therefore, an evaluation value does not improve even when optimization is performed. If such indices are input to the evaluation formula generation unit 132, an adverse effect would be caused such that the evaluation formula 206 to be output by the evaluation formula generation unit 132 may have lowered weights of the indices that should be originally prioritized (indices with which an evaluation value will fluctuate). Consequently, a problem would arise such that the expected value of the improvement of the optimization would decrease. The first index generation unit 131 stores in the index data 205 information on indices that do not satisfy the condition (No in step 302).

Next, the first index generation unit 131 computes the fluidity for the combination of columns that satisfies the condition in step 302 (303). Herein, the term “fluidity” is information about, regarding the combination of columns that satisfies the condition in step 302, a degree representing the number of combinations of columns that are possible. In other words, the “fluidity” represents the degree of change in the combination of columns that is allowed within the change constraints. The fluidity is computed because even when a change in the combination of columns is determined to be allowable for optimization in step 302, for example, there may be cases where the combination does not change in practice depending on the configuration of the change constraint parameter 621.

For example, regarding the input data 204 for optimization in FIG. 6, suppose a case where the pickers 616 of rows whose picker time segment 615 indicates “morning” are only “part-time workers,” and the pickers 616 of rows whose picker time segment 615 indicates “afternoon” are only “regular workers.” In such an example, it is obvious that even when data is exchanged within the change constraints, no change in the combination occurs. That is, since an evaluation value does not change in the optimization, no information is provided. Therefore, the first index generation unit 131 computes the fluidity representing the degree of change in the combination that is allowable within the change constraints designated. Among examples of the computation method is a method of, when data in the data-variable portion 631 is shuffled at random within the change constraints, computing the average change rate S % of the combination of the values of the selected K columns. In the aforementioned example, S=0% since the combination has not changed at all. To the contrary, if the fluidity is high, a positive value such as S=30% results.

The first index generation unit 131 determines if the fluidity S computed in step 303 satisfies an index computation condition (304). An example of the index computation condition herein is a condition that the fluidity S be greater than or equal to a predetermined threshold A. If the fluidity S is greater than or equal to the threshold A, the flow proceeds to step 305. Meanwhile, if the fluidity S is less than the threshold A (No in step 304), the first index generation unit 131 may store in the index data 205 information to the effect that the fluidity S has not satisfied the index computation condition. In the present example, if the fluidity S satisfies the index computation condition is determined based on the preset threshold A, but it is also possible to adopt a combination of columns with the top 30% fluidity S without providing the fixed threshold A.

The first index generation unit 131 computes, regarding the combination of columns that satisfies the index computation condition in step 304, an index using the past explanatory data 201 (305). For example, it is assumed that the combination of K columns herein is the shelf ID 613 and the picker 616. It is also assumed that the combination of columns satisfies the condition in step 302 and also satisfies the condition in step 304. For such combination of columns, the first index generation unit 131 computes an index by applying one or more functions. Herein, a function G1 is used as an example. The function G1 is a function that becomes 1 when “the shelf ID 613 is less than 5” AND “the picker 616 is a “part-time worker” and becomes zero otherwise. If the function G1 is applied to the past explanatory data 201, the data vector becomes (0, 0, 1, 0, . . . ). The first index generation unit 131 stores in the index data 205 the applied function and the data vector computed using the function.

Herein, as the function, one or more functions may be prepared in advance, or one or more functions generated dynamically by using clustering or the like may also be used. In addition, all of the functions that are prepared in advance or generated dynamically may be applied to the past explanatory data 201. It should be noted that when a plurality of functions is applied, indices are generated in a number corresponding to the applied functions.

The first index generation unit 131 determines if all combinations of columns have been selected (306). For example, it is assumed that a combination of less than or equal to 3 columns is set as the condition of the combination of columns. In such a case, the first index generation unit 131 determines if the flow of FIG. 3 has been conducted on all of 1 column, combinations of 2 columns, and a combination of 3 columns. If the selection of all combinations of columns in accordance with the aforementioned condition is complete, the process is terminated. If the selection is not complete, steps 301 to 306 are repeatedly executed.

FIG. 7 shows an example of a specific data form of the index data 205. The index data 205 includes, as the columns, an index ID 701, input column 702, changeability condition 703, fluidity 704 within the constraints, function 705, and data vector 706.

The index ID 701 is an ID that can uniquely identify an index generated. The input column 702 contains information on a combination of columns to serve as an index in optimization of the input data 204 for optimization, that is, a combination of columns selected in step 301 of FIG. 3.

The changeability condition 703 is changeability information indicating if data in each column is allowed to be changed in the optimization, and is a value that indicates if the condition in step 302 is satisfied. As the changeability condition 703, “changeable” is stored if the condition in step 302 is satisfied, and “unchangeable” is stored if the condition in step 302 is not satisfied.

The fluidity S computed in step 303 is stored as the fluidity 704 within the constraints. The function applied in step 305 is stored as the function 705. The value of the index computed in step 305 is stored as the data vector 706. It should be noted that if the condition in step 302 is not satisfied, “−” is stored as the function 705 and the data vector 706.

Next, an evaluation formula will be described. The evaluation formula generation unit 132 performs regression analysis of a column corresponding to the objective index of the past objective data 202 using the index data 205. The index data 205 contains information about if the generated index is an effective index as described above. Therefore, the evaluation formula generation unit 132 constructs the evaluation formula 206 using only an effective index in the index data 205.

That is, the evaluation formula generation unit 132 generates the evaluation formula 206 using only an index that includes at least one data-variable portion 631 and at least one data-invariable portion 632 among combinations of columns in the index data 205. In addition, the evaluation formula generation unit 132 generates the evaluation formula 206 using only an index whose fluidity 704 within the constraints satisfies a predetermined condition in the index data 205. The predetermined condition herein may be set using a threshold.

A method for constructing the evaluation formula may be any method as long as it is a common regression modeling method. For example, examples of linear regression modeling include a multiple regression equation, LASSO regression, and a RIDGE regression equation. Further, a non-linear regression equation can also be used. This embodiment will describe an example in which a multiple regression equation is simply used.

The evaluation formula 206 is Y=F(X) for regression of the productivity Y. An example of the evaluation formula generated using a multiple regression equation is represented by Equation (1). Equation (1) is an equation in which, as the terms of the multiple regression equation, two indices G1 (shelf ID<5, picker=part-time worker) and G2 (shelf type=big, picker=regular worker) are linearly combined using coefficients A1 and A2. G1 is a function that becomes 1 when the “the shelf ID is less than 5” AND “the picker is a part-time worker” and becomes zero otherwise. G2 is a function that becomes 1 when “the shelf type is big” AND “the picker is a regular worker” and becomes zero otherwise.

F(X)=A1*G1(shelf ID<5, picker=part-time worker)+A2*G2(shelf type=big, picker=regular worker) Equation (1)

The function used in this embodiment can have any given form. For example, the function may include operators other than “AND,” such as “OR” or “XOR.” Further, the function may also include a set operator, such as a mean or variance.

FIG. 8 is a flow illustrating step 213 in FIG. 2. In this flow, a combination of pieces of data in the input data 204 for optimization is changed under the conditions of the optimization configuration parameter 203 so that the evaluation value of the generated evaluation formula 206 improves.

The optimization unit 133 receives as inputs the evaluation formula 206, the optimization configuration parameter 203, and the input data 204 for optimization. The optimization unit 133 exchanges data in the data-variable portion 631 of the input data 204 for optimization at random within the range that the values of the constraint portion 633 are the same (801). FIG. 6 shows a specific example of such a process of changing a combination. For example, the first and fourth rows of the data portion 602 each have the picker time segment 615 indicating “morning” and thus have the same value. In this manner, the optimization unit 133 exchanges the values of the picker 616 in the first and fourth rows of the data portion 602 within the range that the values of the constraint portion 633 are the same.

The optimization unit 133 re-computes all indices used for the evaluation formula 206 regarding the input data 204 for optimization whose combination of pieces of data has been changed in step 801 (802). Herein, assume an example in which the evaluation formula 206 is Equation (1) and the index data 205 is the data shown in FIG. 7. The optimization unit 133 re-computes the data vector 706 corresponding to the index ID 701 (=3, 4) used for the evaluation formula 206 in the index data 205.

The optimization unit 133 computes the evaluation formula Y=F(X) for the input data 204 for optimization whose combination of pieces of has been changed, using the index data 205 re-computed in step 802 and the evaluation formula 206 (803).

The optimization unit 133 determines if the evaluation value Y has converged (804). Specifically, the optimization unit 133 determines (1) if fluctuations of the evaluation value Y have converged or (2) if the number of changes made to the combination in step 801 has reached a predetermined condition. The optimization unit 133, if the condition of (1) or (2) above is satisfied, outputs the input data 204 for optimization at that time as the optimized data 207. Then, the present flow terminates.

Meanwhile, if neither the condition (1) nor (2) above is satisfied, the optimization unit 133 determines if the evaluation value Y has improved (805). Specifically, the optimization unit 133 determines if the evaluation value Y has improved with the change made to the combination this time. If the evaluation value Y has improved, the optimization unit 133 executes a process of repeating steps 801 to 804 using the input data 204 for optimization at that time as the input data. Meanwhile, if the evaluation value Y has not improved, the optimization unit 133 restores the combination to the last combination of pieces of data of the input data for optimization (806). After that, the optimization unit 133 executes a process of repeating steps 801 to 804 using the last combination of pieces of data of the input data for optimization as the input data. At this time, even if a given combination of pieces of data of the input data for optimization is adapted when no improvement in the evaluation value Y is seen at some probability, like simulated annealing, it is possible to avoid local optimization.

The advantageous effects of the aforementioned embodiment will be described. When an evaluation formula that recursively performs regression of an objective variable from data is used to perform optimization for which constraints are taken into consideration, the resulting optimization effects may become significantly low depending on the constraints. In contrast, in the aforementioned embodiment, when data containing a number of explanatory variables and an objective variable (the past explanatory data 201 and the past objective data 202), data to be optimized (the input data 204 for optimization), and an optimization parameter (the optimization configuration parameter 203) are provided, it is possible to create an evaluation formula for regression of an objective variable for which the data to be optimized and the parameter are taken into consideration. Therefore, the effects of the optimization for which the constraints in the parameter are taken into consideration can be increased.

More specifically, according to this embodiment, a data processing system for analyzing data and creating a model (for example, an evaluation formula) receives a changeability condition indicating if data in each column is allowed to be changed in the optimization of the model, and creates the model on the basis of the changeability condition received. Therefore, when optimization for which constraints are taken into consideration is effectively performed, it is possible to create a model for optimization, taking the constraints into consideration in advance.

### Embodiment 2

Next, Embodiment 2 will be described. Embodiment 2 provides a configuration in which the accuracy of the validity of an index is increased by using a result obtained by actually executing the optimized input data.

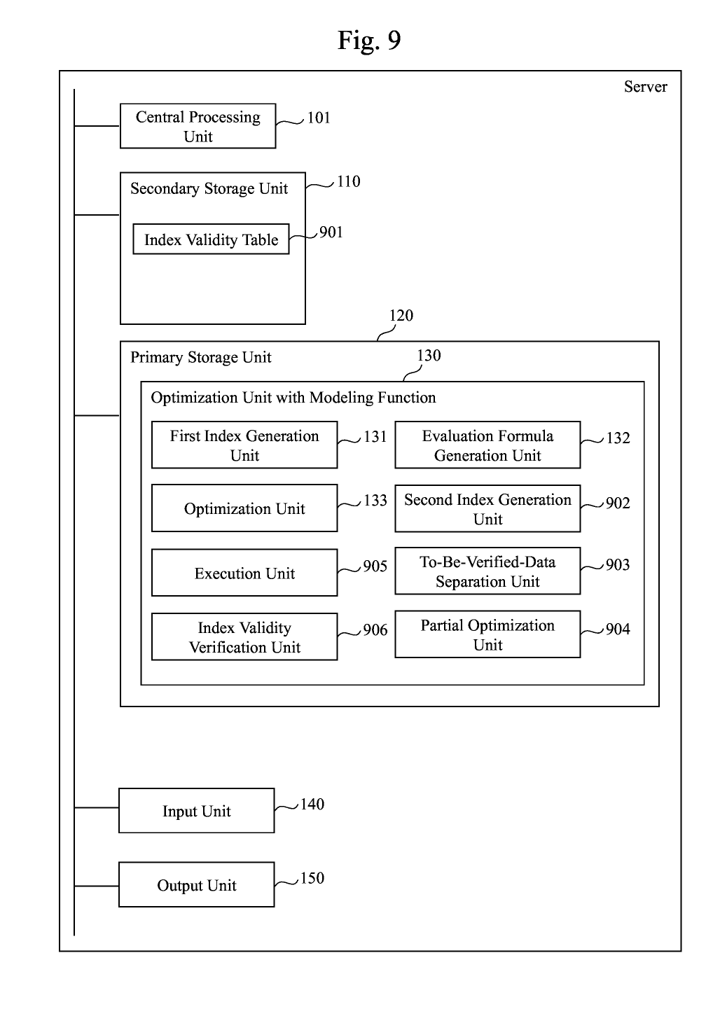

FIG. 9 is a system configuration diagram of the data processing system in this embodiment. The components described in the aforementioned embodiment are denoted by the same reference numerals, and repeated description will be omitted.

The secondary storage unit 110 stores an index validity table 901 that stores the validity when optimization is performed with the present system. In addition, the optimization unit 130 with the modeling function includes, in addition to the components in Embodiment 1, a second index generation unit 902, a to-be-verified-data separation unit 903, a partial optimization unit 904, an execution unit 905, and an index validity verification unit 906.

Each processing module of the optimization unit 130 with the modeling function is implemented as the central processing unit 101 (processor) executes a program corresponding to each processing module, for example. Therefore, in the following description, a process that is performed by the processing module in FIG. 9 may be rephrased as a process that is performed by the processor.

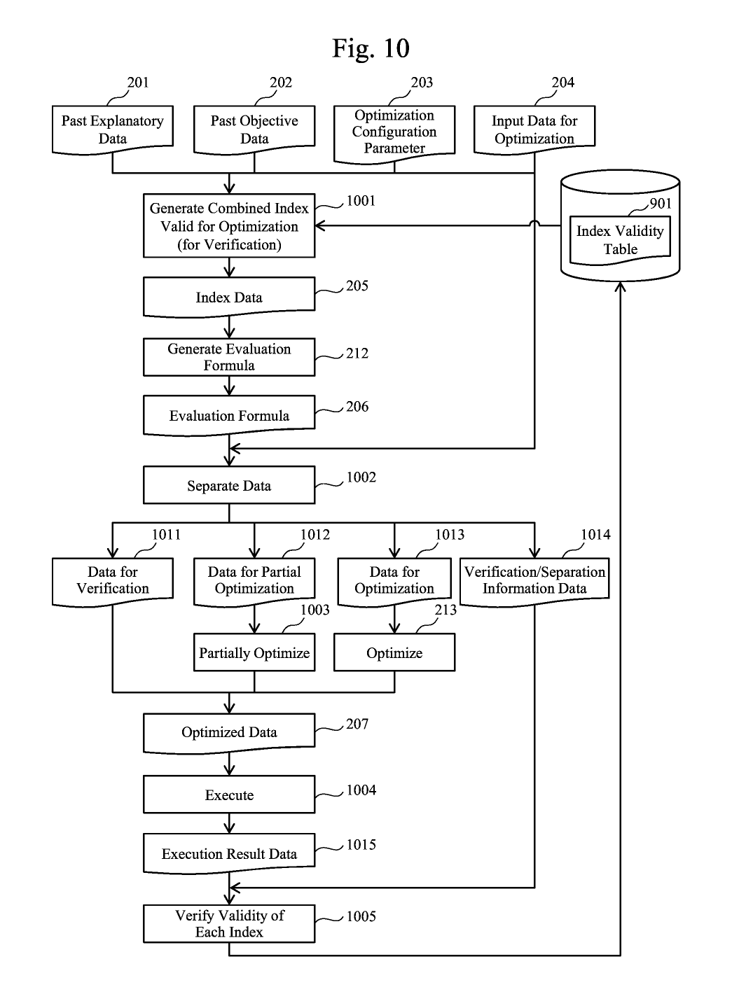

FIG. 10 shows a basic flow of Embodiment 2. It should be noted that the processes and data that are the same as those in the basic flow in Embodiment 1 are denoted by the same reference numerals, and repeated description will be omitted.

The second index generation unit 902 generates only a valid index using information on the index validity table 901 (1001). The detailed process herein will be described later with reference to FIG. 16. The second index generation unit outputs the index data 205 representing a combined index that is valid for optimization.

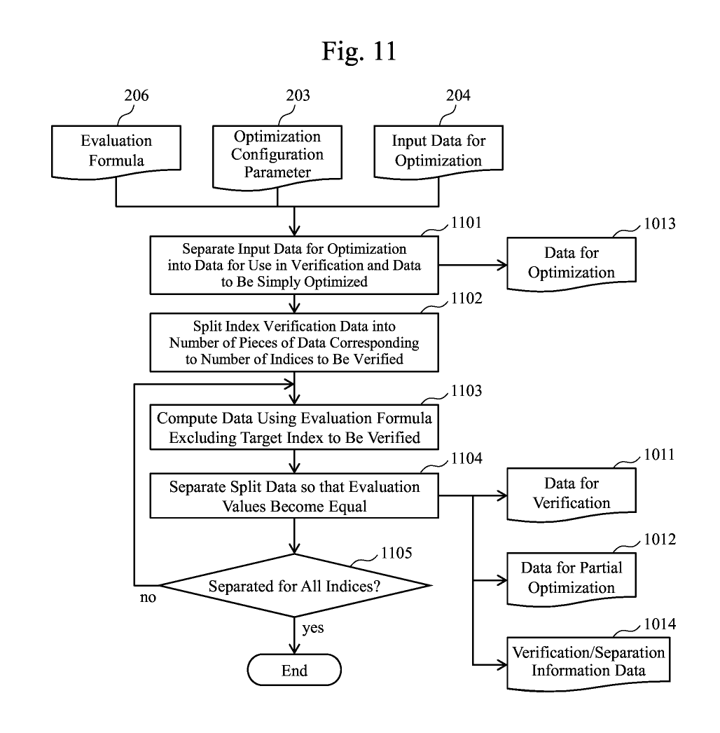

After that, after the evaluation formula 206 is generated, the to-be-verified-data separation unit 903 separates the input data 204 for optimization into a plurality of pieces of data (1002). Specifically, the to-be-verified-data separation unit 903 separates the input data 204 for optimization into data 1011 for verification, data 1012 for partial optimization, and data 1013 for optimization. It should be noted that information on the separation here is stored as verification/separation information data 1014. The detailed process herein will be described below with reference to FIG. 11.

The partial optimization unit 904 performs an optimization process on the data 1012 for partial optimization using an evaluation formula obtained by using only a target index to be verified in the evaluation formulae 206 (1003). The basic optimization method herein is the same as the process performed by the optimization unit 133, but differs in the following point, for example. Herein, it is assumed that verification of the index ID 701=3 of the index data 205 in FIG. 7 is performed. When the data 1012 for partial optimization for verifying the index with the index ID 701=3 is input, the partial optimization unit 904 constructs an evaluation formula (second model) that uses only the index as in Equation (2). To obtain Equation (2), it is possible to extract only a term including the index with the index ID=3 from Equation (1) and use the coefficient and the like as they are, or perform regression of the evaluation formula again using only such a term.

F(X)=A1*G1(shelf ID<5, picker=part-time worker) Equation (2)

The optimized data 207 in this example includes, as shown in FIG. 10, data not optimized as the data 1011 for verification, data partially optimized by the partial optimization unit 904 (that is, data obtained by executing optimization of the data 1012 for partial optimization), and data optimized by the optimization unit 133 (that is, data obtained by executing optimization of the data 1013 for optimization).

The execution unit 905 receives the optimized data 207 as an input, and actually executes some process or operation in accordance with the content of the optimized data 207 (1004). The execution unit 905 outputs the execution result data 1015. Herein, an optimization problem for improving the productivity of picking operations in a warehouse is given as an example. Therefore, the process of the execution unit 905 corresponds to actually executing a picking operation in the warehouse in accordance with the optimized data 207 and outputting the productivity as the execution result data 1015.

Although the present flow shows an example in which all programs are within a single system for simplicity, the configuration is not limited thereto. For example, the execution unit 905 that actually executes an operation in accordance with the content of the optimized data 207 may be provided within another system. In such a case, the data processing system in this embodiment may be configured to send an execution request together with the optimized data 207 to an execution unit 905 in the other system. Alternatively, as another example, an execution unit 905 in another system may be configured to send an optimization request together with the past explanatory data 201, the past objective data 202, the optimization configuration parameter 203, and the input data 204 for optimization to the data processing system in this embodiment.

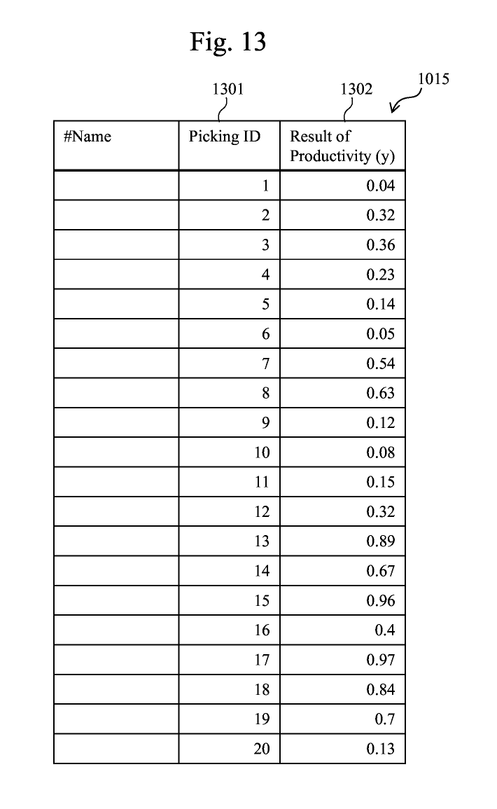

FIG. 13 shows an example of the execution result data 1015 output from the execution unit 905. As the execution result data 1015, the value of a column corresponding to the objective index (herein, the result of productivity) is stored. The execution result data 1015 includes a picking ID 1301 and the result of productivity 1302.

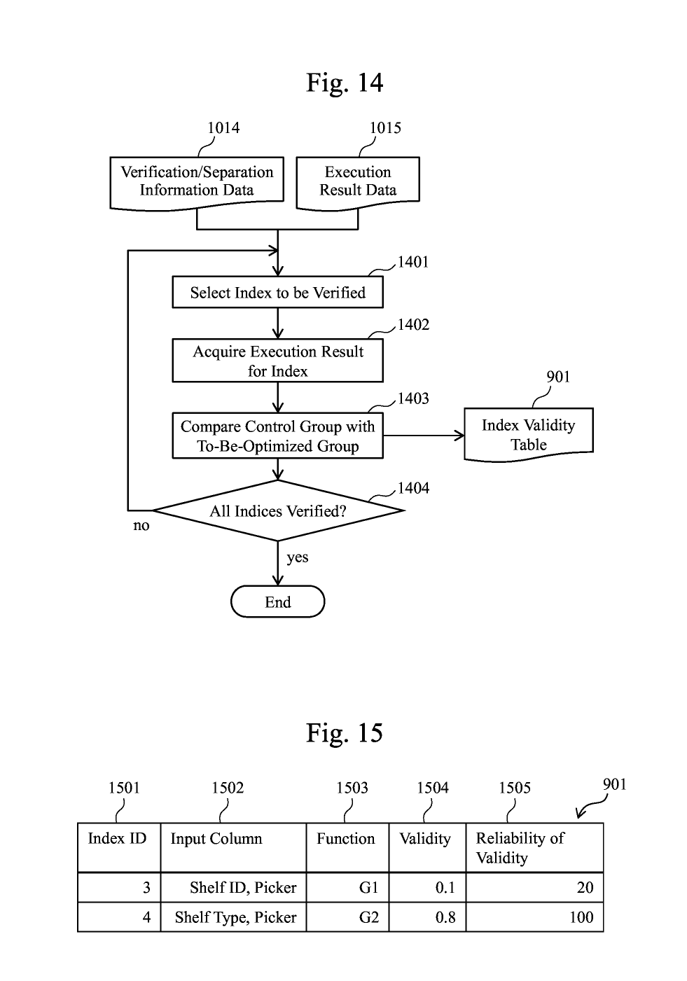

The index validity verification unit 906 receives the execution result data 1015 and the verification/separation information data 1014 as inputs, and verifies the validity of each index (1005). The index validity verification unit 906 records the verified information on the index validity table 111. The detailed process herein will be described later with reference to FIG. 14.

FIG. 11 shows a flow of step 1002 in FIG. 10. The to-be-verified-data separation unit 903 separates the input data 204 for optimization into data to be simply optimized and data used for verification in order to verify if each index used for the evaluation formula 206 is an actually valid index.

The to-be-verified-data separation unit 903 receives as input data the evaluation formula 206, the optimization configuration parameter 203, and the input data 204 for optimization. The to-be-verified-data separation unit 903 separates the input data 204 for optimization into data for use in verification and data to be simply optimized (1101). For example, when 10% of the input data 204 for optimization is used for verification, and the remaining 90% of the data is simply used for optimization, the to-be-verified-data separation unit 903 separates 90% of the data at random from the input data 204 for optimization as the data 1013 for optimization, and uses the remaining data as the data for verification (hereinafter referred to as index verification data) in the next step 1102. In the present process, a major part of the data is optimized while verification is performed. Therefore, optimization and verification can be performed concurrently.

Next, the to-be-verified-data separation unit 903 splits the index verification data into pieces of data corresponding to the number of indices used for the evaluation formula 206 (1102). For example, since two indices are used for the example of Equation (1), the to-be-verified-data separation unit 903 splits the index verification data into two pieces of split data (first data and second data).

Next, the to-be-verified-data separation unit 903 creates an evaluation formula excluding the target index to be verified, and computes the split data using the evaluation formula (1103). Herein, it is assumed that the index ID 701=3 of the index data 205 in FIG. 7 is verified. The to-be-verified-data separation unit 903 creates Equation (3) obtained by excluding the target index to be verified from Equation (1). The to-be-verified-data separation unit 903 computes an evaluation value of each row of the first data using Equation (3).

F(X)=A2*G2(shelf type=big, picker=regular worker) Equation (3)

It should be noted that when the index ID 701=4 of the index data 205 in FIG. 7 is verified, the to-be-verified-data separation unit 903 may create an equation obtained by excluding the target index to be verified from Equation (1), and compute an evaluation value of each row of the second data using the equation.

Next, the to-be-verified-data separation unit 903 separates the split data into the data 1011 for verification and the data 1012 for partial optimization so that the evaluation values computed in step 1103 become substantially equal (1104). “Evaluation values that are substantially equal” may be determined through determination of if the difference between the evaluation values is smaller than a given threshold. For example, the to-be-verified-data separation unit 903 separates the first data into the data 1011 for verification and the data 1012 for partial optimization so that the evaluation values computed using Equation (3) in step 1103 become equal. In addition, the to-be-verified-data separation unit 903 outputs information about which row of the input data 204 for optimization has been separated into which data as the verification/separation information data 1014.

Although Equation (3) excluding the target index to be verified has been created in step 1103 above, it is also possible to use Equation (1) as the evaluation formula without excluding the target index to be verified.

Next, the to-be-verified-data separation unit 903 determines if the separation is complete (1105). Specifically, the to-be-verified-data separation unit 903 determines if, regarding all indices, the data has been separated into the data 1011 for verification and the data 1012 for partial optimization. If the separation of the data is complete for all indices, the process is terminated. If the separation has is not complete, steps 1103 to 1104 are repeatedly executed.

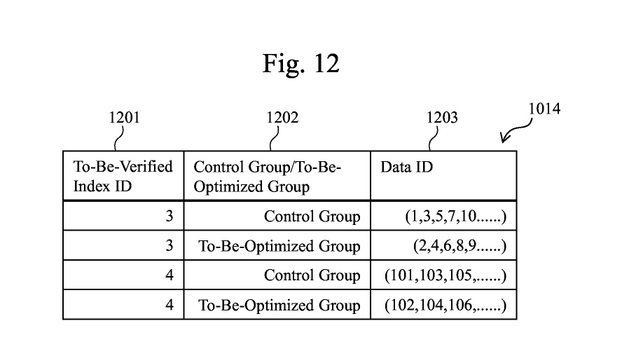

FIG. 12 shows an example of a specific data form of the verification/separation information data 1014. The verification/separation information data 1014 includes a to-be-verified index ID 1201, control group/to-be-optimized group 1202, and data ID 1203.

As the to-be-verified index ID 1201, the index ID of a target index to be verified is stored. The to-be-verified index ID 1201 corresponds to the index ID 701 of the index data 205.

As the control group/to-be-optimized group 1202, a flag indicating if the relevant data is data for verification or data to be partially optimized is stored. In this example, a “control group” is stored as a flag indicating the data 1011 for verification (data not to be optimized). In addition, a “to-be-optimized group” is stored as a flag indicating the data 1012 for partial optimization.

As the data ID 1203, information about which row of the input data 204 for optimization belongs to which group is stored. In the example of FIG. 4, the picking ID 611 is the column that uniquely designates each row of the input data 204 for optimization. Therefore, the vector of the corresponding picking ID is stored as the data ID 1203.

FIG. 14 shows a flow illustrating step 1005 in FIG. 10. The index validity verification unit 906 verifies if each index has been actually valid for optimization.

The index validity verification unit 906 receives as input data the verification/separation information data 1014 and the execution result data 1015. The index validity verification unit 906 selects a target index to be verified from the verification/separation information data 1014 (1401). Herein, it is assumed that an index with the index ID 1201=3 to be verified is selected as the target index to be verified.

The index validity verification unit 906 reads from the verification/separation information data 1014 the data ID 1203 of the control group of the target index to be verified and the data ID 1203 of the to-be-optimized group. The index validity verification unit 906 extracts from the execution result data 1015 the result of productivity 1302 corresponding to the data ID 1203 of the control group and the result of productivity 1302 corresponding to the data ID 1203 of the to-be-optimized group (1402). Herein, as the execution result of the control group, data on the picking ID 1301=(1, 3, 5, . . . ) is extracted from the execution result data 1015. In addition, as the execution result of the to-be-optimized group, data on the picking ID 1301=(2, 4, 6, . . . ) is extracted from the execution result data 1015.

The index validity verification unit 906 compares the result of productivity 1302 of the control group with the result of productivity 1302 of the to-be-optimized group (1403). The index validity verification unit 906 stores in the index validity table 901 a result indicating if the productivity that is the objective index has been significantly improved by the index with the index ID 1201=3 to be verified. Comparison between the productivities of the two groups can be performed using a statistical technique, such as comparison of mean values or analysis of variance.

It should be noted that when the flow in FIG. 14 is repeatedly executed, there may be cases where the validity of the relevant index is already stored in the index validity table 901. In such a case, a method of storing only information with high validity in the index validity table 901 may be performed.

Repeatedly executing such a flow can accumulate the validity of indices in the index validity table 901. With the index validity table 901, it is possible to use only an index with high validity for creating an evaluation formula.

Next, the index validity verification unit 906 determines if the verification is complete (1404). If the verification for all indices is complete, the index validity verification unit 906 terminates the process. If the verification is not complete, steps 1401 to 1403 are repeatedly executed.

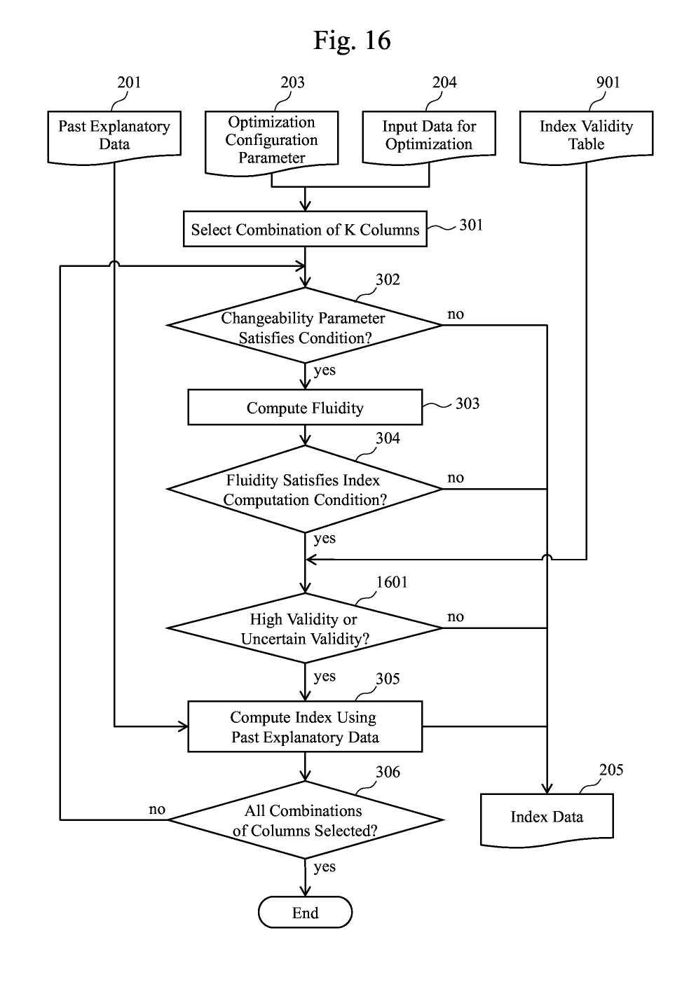

FIG. 15 shows an example of a specific data form of the index validity table 901. The index validity table 901 stores a result of verifying the validity of each index. The index validity table 901 includes an index ID1501, input column 1502, function 1503, validity 1504, and reliability 1505 of the validity.

As the index ID 1501, the index ID of the verified index is stored. The index ID 1501 corresponds to the index ID 701 of FIG. 7. As the input column 1502, a combination of columns to serve as the index is stored. The input column 1502 corresponds to the input column 702 of FIG. 7. As the function 1503, a function related to the index is stored. The function 1503 corresponds to the function 705 of FIG. 7.

As the validity 1504, validity verified through the process of comparing the control group with the to-be-optimized group (step 1403 in FIG. 14) is stored. For example, the difference between the mean value of the to-be-optimized group and the mean value of the control group may be used as the validity 1504.

As the reliability 1505 of the validity, information on the reliability of the validity 1504 is stored. That is, for example, even if the difference between the mean value of the to-be-optimized group and the mean value of the control group is large, if the variance of each group is greater than that, the difference between the mean values cannot be said to be significant. Therefore, the reliability 1505 of the validity is used to prevent an index from being determined to be valid in such a case. As the reliability 1505 of the validity, the inverse of the rejection probability of analysis of variance may be used, for example.

FIG. 16 shows a flow illustrating step 1001 in FIG. 10. This flow is basically the same as that in FIG. 3. Hereinafter, only different processes will be described.

Step 1601 is inserted between steps 304 and 305. The second index generation unit 902 searches the index validity table 901 for an index that can be generated by a combination of the K columns. For example, the second index generation unit 902 acquires from the index validity table 901 an index with high validity or an index with uncertain validity. Herein, the “index with high validity” means an index whose validity 1504 is higher than a given threshold. In addition, the “index with uncertain validity” means an index whose reliability 1505 of the validity is lower than a given threshold. Herein, if the validity of an index is low and the reliability of the validity is high, adverse effects may be caused as described above even when the index is generated. Therefore, the second index generation unit 902 may store, regarding such an index that may have adverse effects, information to the effect that such an index should not be used for optimization, in the index data 205.

In the next process, the second index generation unit 902 computes an index for the combination of K columns acquired in step 1601, using the past explanatory data 201. Through the aforementioned flow, the second index generation unit 902 can output an index with high validity as the index data 205.

According to Embodiment 2 described above, the second index generation unit 902 can create the index data 205 containing only an index (a combination of columns) that is valid for optimization with reference to the index validity table 901. The evaluation formula generation unit 132 can generate the evaluation formula 206 using the index data 205 having stored therein an index verified as having high validity.

In the aforementioned example, among the indices stored in the index validity table 901, an index with high validity or with uncertain validity is used to create an evaluation formula, while an index with low validity and with high reliability of the validity is not used to create an evaluation formula. The method of using the index validity table 901 is not limited to such an example. For example, the second index generation unit 902 may compute the importance of an index from the validity 1504 and the reliability 1505 of the validity in the index validity table 901, and add information on the importance to the index data 205. The evaluation formula generation unit 132 may create an evaluation formula using the importance of each index as the weight of each index.

The present invention is not limited to the aforementioned embodiments, and includes a variety of variations. For example, although the aforementioned embodiments have been described in detail to clearly illustrate the present invention, the present invention need not include all of the configurations described in the embodiments. It is possible to replace a part of a configuration of an embodiment with a configuration of another embodiment. In addition, it is also possible to add, to a configuration of an embodiment, a configuration of another embodiment. Further, it is also possible to, for a part of a configuration of each embodiment, add, remove, or substitute a configuration of another embodiment.

In addition, some or all of the aforementioned configurations, functions, processing units, processing means, and the like may be implemented as hardware through designing with integrated circuits, for example. Alternatively, it is also possible to implement each of the aforementioned configurations, functions, and the like as software by causing the processor to analyze and execute a program that implements each function. Information such as a program, table, and file that implements each function can be stored in a variety of types of non-transitory computer readable media. Examples of non-transitory computer readable media include a flexible disk, CD-ROM, DVD-ROM, hard disk, optical disc, magneto-optical disk, CD-R, magnetic tape, a nonvolatile memory card, and ROM.

In the aforementioned embodiments, the control lines and information lines represent those that are considered to be necessary for the description, and do not necessarily represent all of the control lines and information lines that are necessary for a product. Thus, in practice, almost all of the elements may be mutually connected.

### REFERENCE SIGNS LIST

101 Central processing unit
110 Secondary storage unit
111 Index validity table
120 Primary storage unit
130 Optimization unit with a modeling function
131 First index generation unit
132 Evaluation formula generation unit
133 Optimization unit
140 Input unit
150 Output unit
201 Past explanatory data
202 Past objective data
203 Optimization configuration parameter
204 Input data for optimization
205 Index data
206 Evaluation formula
207 Optimized data
901 Index validity table
902 Second index generation unit
903 To-be-verified-data separation unit
904 Partial optimization unit
905 Execution unit
906 Index validity verification unit
1011 Data for verification
1012 Data for partial optimization
1013 Data for optimization
1014 Verification/separation information data
1015 Execution result data

1. A data processing system for creating a model for optimizing input data including a plurality of columns, comprising a processor and a storage unit, wherein:
the processor is configured to
receive index data including information on a combination of the columns to serve as an index in optimization of the input data, and changeability information indicating if data in each column is allowed to be changed in the optimization, and
create the model on the basis of the index data.

2. The data processing system according to claim 1, wherein the processor is configured to generate the model using, as the index, only the combination of columns that includes at least one data-changeable column and at least one data-unchangeable column.

3. The data processing system according to claim 2,
wherein:
the index data further includes, regarding the at least one data-changeable column, information on fluidity, the fluidity being a degree representing the number of combinations of columns that are possible, and
the processor is configured to generate the model using only the index with the fluidity that satisfies a predetermined condition.

4. The data processing system according to claim 1,
wherein:
the index data further includes a value of the index computed on the basis of past data using a given function, and
the processor is configured to generate the model using the value of the index.

5. The data processing system according to claim 1, wherein the processor is configured to receive constraint information for optimizing the input data, optimize the input data on the basis of the constraint information and the model, and output resulting optimized data.

6. The data processing system according to claim 5, further comprising an execution unit configured to execute a process using the optimized data and output execution result data.

7. The data processing system according to claim 6,
wherein:
the storage unit is configured to store index validity information representing validity of indices, and
the processor is configured to
split the input data into a plurality of pieces of data for each index, verify validity of each index from the execution result data, and store the validity of each index as the index validity information in the storage unit.

8. The data processing system according to claim 7, wherein the processor is configured to create the index data using the index validity information.

9. The data processing system according to claim 7,
wherein:
the plurality of pieces of data includes data for verification that is to be not optimized and data to be partially optimized, and
the processor is configured to generate, for the data to be partially optimized,
a second model that uses only a target index to be verified, and
performs optimization using the second model.

10. The data processing system according to claim 9, wherein the processor is configured to verify the validity of the index by comparing data corresponding to the data for verification in the execution result data with data corresponding to the data to be partially optimized in the execution result data.

11. The data processing system according to claim 9,
wherein the processor is configured to
generate a third model obtained by excluding the target index to be verified from the model, and
separate the plurality of pieces of data into the data for verification and the data to be partially optimized so that evaluation values computed using the third model become substantially equal.

12. A data processing method for creating a model for optimizing input data including a plurality of columns, comprising:
receiving, with a processor, index data including information on a combination of the columns to serve as an index in optimization of the input data, and changeability information indicating if data in each column is allowed to be changed in the optimization, and
creating, with the processor, the model on the basis of the index data.
